(19) United States
(12) Patent Application Publication
(10) Pub. No.: US 2006/0222883 A1
(43) Pub. Date: Oct. 5, 2006

(54) Surface modification method for conductive metal material

(75) Inventors: Ryoji Kaku, Tokyo (JP); Masafumi Okada, Saitama (JP)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: Japan Aviation Electronics Industry Limited, Tokyo (JP)

(21) Appl. No.: 11/387,194

(22) Filed: Mar. 22, 2006

(30) Foreign Application Priority Data
Mar. 29, 2005 (JP) 2005-093851

(51) Int. Cl. B23P 9/00; B24B 39/00

(52) U.S. Cl. 428/687; 29/90.7

(57) ABSTRACT

Spherical particles having curvatures larger than those of irregularities, crystal grain boundaries, lattice defects or the like (referred to collectively as irregularities, hereinafter) on the surface of a conductive metal material are ejected at high speeds to make the particles collide against the surface of the conductive metal material, thereby repeatedly causing rapid melting and cooling at the minute points of impact of the particles, thereby changing the surface into amorphous. Then, spherical particles having curvatures smaller than those of irregularities on the surface subjected to the treatment described above collide against the surface, thereby changing the surface into amorphous and planarizing the surface.

### BACKGROUND OF THE INVENTION

1. Field of the Invention

The present invention relates to a method of modifying a surface of a conductive metal material to enhance the corrosion resistance and electrical contactivity thereof that is used to establish good electrical connection, a conductive metal material having a high corrosion resistance and a high electrical contactivity, a contact member made of the conductive metal material, and a connector that is an electrical connecting device having the contact member.

2. Description of the Related Art

In many electrical connecting devices, such as a connector, a conductive metal material, such as a copper alloy, that is a good conductor and has a high elasticity and a high workability, is used for a contact member for establishing electrical connection. If the surface of the copper alloy is corroded, the contact resistance increases. Thus, the surface is plated with gold or tin to enhance the corrosion resistance.

In Japanese Patent Application Laid-Open No. 8-150483 (referred to as literature 1, hereinafter) which is laid open in 1996, there is disclosed a method of improving the surface hardness, abrasion resistance and electrical characteristics of an electrode tip (nozzle) used for resistance welding, such as spot welding and seam welding. According to this prior art, particles having a hardness of 1,000 Hv and a particle diameter of 75 to 300 μm are ejected at a speed of 180 m/sec or higher for 5 to 15 seconds and to collide against the surface of the electrode made of a non-ferrous metal, thereby repeatedly heating the region close to the surface of the electrode to the crystallization temperature or higher and letting the region cool to room temperature. In this way, recovery and recrystallization are caused at the surface of the electrode, thereby refining the metallographic structure. In addition, this literature 1 discloses that lattice defects are reduced by the recovery and recrystallization process, and the mechanical and electrical characteristics of the surface of the electrode change.

In Japanese Patent Application Laid-Open No. 62-278224 (referred to as literature 2, hereinafter) which is laid open in 1987, there is proposed a method of increasing the abrasion resistance and fatigue strength of a metal surface by ejecting particles having a hardness approximately equal to or more than the finished hardness of the metal surface and a diameter of 40 to 200 μm at a speed of 100 m/sec or higher to make the particles collide against the metal surface, thereby rapidly increasing and decreasing the temperature of the region close to the surface, thereby changing the state of the surface layer to increase the hardness thereof, although this method does not relate to the contact member.

In addition, in Japanese Patent Application Laid-Open No. 4-331070 (referred to as literature 3, hereinafter) which is laid open in 1992, there is proposed a method of elongating the lifetime of a tool by refining and densifying the surface structure thereof by spraying spherical abrasives having a grain size of 300 to 800 mesh onto the surface along with a gas flow at a pressure of 3 to 10 kg/cm².

Furthermore, for the purpose of enhancing the fatigue strength of a power transmission mechanical component, such as a power transmission axis and a gear, Japanese Patent Application Laid-Open No. 61-124521 (referred to as literature 4, hereinafter) which is laid open in 1986 discloses a method of providing a product having a good surface roughness by austempering a steel to be processed to change the steel into bainite, performing a first shot peening with a shot diameter of 0.6 to 0.8 mm, a projection speed of 35 to 50 m/s and projection duration of 5 to 40 ms to form a deep surface treatment layer, and following the first shot peening in a moderate temperature range, performing a second shot peening under the same conditions, or preferably with a smaller shot diameter of 0.3 to 0.5 mm, thereby further improving the compressive residual stress in the surface.

As for the prior arts described above, a plating technique for improving corrosion resistance has a problem that a large or large-scale installation, such as a plating bath and a disposal installation, is required.

The technical field of the prior art disclosed in the literature 1 is not relevant to the present invention, and although a particle collision (particle bombarding) treatment is used, the electrical contactivity is not sufficiently improved because the treatment is performed only once. In addition, the literature 1 contains no description about corrosion resistance, and it can be considered that a sufficient corrosion resistance is not achieved by performing the treatment only once.

The technical fields and purposes of the prior arts disclosed in the literatures 2 and 3 are not relevant to the present invention, and there is a question as to whether the electrical contactivity is improved or not. In addition, both the prior arts involve only one particle collision treatment, and it can be considered that, if the prior arts are applied to a contact member, neither a sufficient electrical contactivity nor a sufficient corrosion resistance are not achieved.

According to the prior art disclosed in the literature 4, the second treatment uses particles having a diameter smaller than particles used in the first treatment. However, the technical field and purpose of the prior art is not relevant to the present invention, and therefore, it cannot be contemplated that this prior art is utilized to improve the corrosion resistance and electrical contactivity of a contact member. If this prior art is used to improve the corrosion resistance and electrical contactivity of a contact member, a good electrical contactivity cannot be achieved.

### SUMMARY OF THE INVENTION

The present invention provides a surface modification method for a conductive metal material that improves the corrosion resistance and electrical contactivity of the surface of the conductive metal material, a conductive metal material having improved corrosion resistance and a high electrical contactivity, a contact member made of the conductive metal material, and a connector, which is an electrical connecting device, that has the contact member.

In a surface modification method for a conductive metal material according to the present invention, a first modification treatment is performed by bombarding the surface of the conductive metal material with spherical particles, each of which is made of a material that does not crack if the particle collides against the conductive metal material and has a curvature approximately equal to or more than curvatures of irregularities on the surface of the conductive metal material. Then, a second modification treatment is performed by bombarding the surface of the conductive metal material subjected to the first modification treatment with spherical particles, each of which is made of a material that does not crack if the particle collides against the conductive metal material and has a curvature less than curvatures of irregularities on the surface of the conductive metal material subjected to the first modification treatment.

A conductive metal material according to the present invention has an amorphous layer having a thickness of at least approximately 10 A at the surface thereof, the size of crystal grains of the conductive metal material under the amorphous layer decreases as the distance from the amorphous layer decreases, and the surface of the amorphous layer is planarized compared with a surface having irregularities that can become a starting point of corrosion.

A contact member according to the present invention is made of the conductive metal material described above and can establish a good electrical connection and has a high corrosion resistance because the surface is composed of an amorphous layer and more planarized than a surface having irregularities that can become a starting point of corrosion.

A connector according to the present invention has a contact section that comprises the contact member described above, can establish a good electrical connection, and has a high corrosion resistance and a long life.

In the surface modification method according to the present invention, the first modification treatment changes the entire surface of the conductive metal material into amorphous and reduces the curvatures of irregularities thereon, and the resulting surface is planarized by the second modification treatment. Thus, a high corrosion resistance and a high electrical contactivity are achieved, and a large installation, such as a plating bath and a disposal installation, is not required.

### BRIEF DESCRIPTION OF THE DRAWINGS

FIG. 1 is a schematic diagram showing a configuration of an apparatus that implements a method according to the present invention;

FIG. 2 shows a result of numerical analysis of a temperature distribution in the case where high-speed particles are made to successively collide against a metal surface in a pulse-like manner according to a prior art;

FIG. 3 is a diagram showing a simulation of collision of spherical particles against the surface of a to-be-modified base material according to the method according to the present invention;

FIG. 4 shows a partial cross section of the to-be-modified base material whose surface is modified and a change of crystal grain diameter along the depth of the to-be-modified base material;

FIG. 5 is a graph showing results of a corrosion resistance test, which proves that the to-be-modified base material whose surface is modified according to the present invention has an improved corrosion resistance;

FIG. 6A is a cross-sectional view showing irregularities on the surface of the to-be-modified base material yet to be modified;

FIG. 6B is a cross-sectional view of the to-be-modified base material that is subjected to a modification treatment under an experimental condition 1;

FIG. 6C is a cross-sectional view of the to-be-modified base material that is subjected to a modification treatment under an experimental condition 2;

FIG. 6D is a cross-sectional view of the to-be-modified base material that is subjected to a modification treatment under an experimental condition 4; and

FIG. 7 is a perspective view of a connector according to the present invention.

### DETAILED DESCRIPTION OF THE PREFERRED EMBODIMENTS

[Configuration of Apparatus]

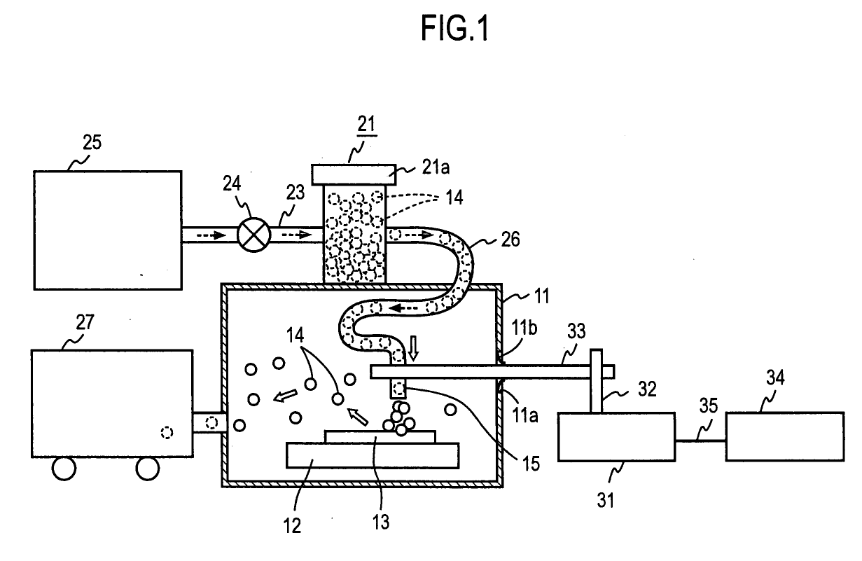

First, a configuration of a surface modification apparatus for a base material that implements a method according to the present invention will be schematically described with reference to FIG. 1.

A stage 12 is disposed in a processing chamber 11, and a to-be-modified base material (or a sample) 13 of a conductive metal material, which is used as a contact member, is placed on the stage 12. In this case, for example, a reference position or a plurality of reference points are established, so that the to-be-modified base material 13 can be positioned adequately on the stage 12.

Spherical particles 14 are ejected from a nozzle 15 onto the to-be-modified base material 13 to collide against the to-be-modified base material 13. To this end, for example, a pressure tank 21, which contains the particles 14 charged thereinto by opening a lid 21 a thereof, is disposed on the processing chamber 11. The lid 21 a is closed tightly enough to withstand the pressure required to eject the particles 14 from the tank 21 with a sufficient pressure. Each of particles 14 is made of a material that does not crack when it collides against the to-be-modified base material 13 and has a spherical shape so that it does not damage the to-be-modified base material 13. The pressure tank 21 is in communication with a compressor 25 via a pipe 23, and the compressor 25 supplies a pressurized gas, such as compressed air, into the pressure tank 21 via a pressure regulator 24. In addition, the pressure tank 21 and the processing chamber 11 are in communication with each other via a pipe 26, and one end of the pipe 26 is introduced into the pressure tank 21. A part of the pipe 26 distant from the end of the pipe 26 introduced into the pressure tank 21 is introduced into the processing chamber 11, and the other end of the pipe 26 constitutes a nozzle 15.

The pipe 26 is made of a relatively flexible material so that a particle ejection port of the nozzle 15 can be positioned with respect to any point on the stage 12.

A nozzle driving unit 31 is disposed outside the processing chamber 11, and a movable member 32 protrudes from the nozzle driving unit 31. The movable member 32 is moved by a driving mechanism in the nozzle driving unit 31 to any position on a two-dimensional coordinate system (or a plane). One end of a linkage bar 33 is fixed to the movable member 32. A part of the linkage bar 33 distant from the end thereof fixed to the movable member 32 is introduced into the processing chamber 11 via an opening 11 a formed in the processing chamber 11, and the nozzle 15 is attached to the other end of the linkage bar 33.

An electrical control signal supplied from a control unit 34 is input to the nozzle driving unit 31 via a cable 35, and the nozzle driving unit 31 is controlled based on the control signal. The nozzle driving unit 31 actuates the movable member 32 according to the control signal. Actuation of the movable member 32 causes the nozzle 15 to be moved to a position determined by the control signal on the stage 12, or in other words, on the to-be-modified base material 13. In order to achieve such movement control, the reference position or point on the stage 12 and the position of the movable member 32 that moves in the two-dimensional coordinate system are previously associated with each other. The nozzle driving unit 31 has a mechanism similar to that of the so-called XY stage driving unit 31.

The pressurized gas supplied from the compressor 25 is introduced into the pressure tank 21 at a pressure regulated by the pressure regulator. Thus, the particles 14 in the pressure tank 21 are ejected from the nozzle 15 through the pipe 26 at a high speed. Each of particles 14 ejected from the nozzle 15 collides against the to-be-modified base material 13, and each of particles 14 after collision is collected by a dust collector 27 linked to the processing chamber 11 for reuse. The clearance between the edge of the opening 11a of the processing chamber 11 and the linkage bar 33 is sealed with an elastic piece 11b, such as a rubber piece, to prevent the particle 14 from escaping to the outside while allowing free movement of the linkage bar 33.

[Embodiment 1]

According to the present invention, following a first modification treatment, a second modification treatment is performed. Before the modification treatments, fine irregularities, grain boundaries or lattice defects are found on the surface of a to-be-modified base material 13, and they are referred to collectively as irregularities in this specification. For the first modification treatment, a spherical particle 14 is used that has a curvature approximately equal to or more than the curvatures of the surface irregularities of the to-be-modified base material 13. More specifically, a spherical particle 14 is used that has a diameter approximately equal to or less than the distance across the smallest recess of the irregularities on the surface of the to-be-modified base material 13.

In other words, a spherical particle 14 is used that has a curvature approximately equal to or more than the largest one of the curvatures of the irregularities on the surface of the to-be-modified base material 13. Besides, as the spherical particle 14, for example, an alumina particle is used, which has a relatively high fracture toughness and therefore can efficiently transmit the kinetic energy to the to-be-modified base material 13 without cracking when it collides against the to-be-modified base material 13 at a high speed.

At room temperature, multiple spherical particles 14 are made to substantially successively collide against the surface of the to-be-modified base material 13 at high speeds. For example, it is supposed that the inner diameter of a nozzle 15 is 1.2 mm or more, the ejection pressure is 3 kg/m² or higher, and the ejection duration is 10 seconds or longer. Each of spherical particles 14, which collides against the surface of the to-be-modified base material 13, has a high kinetic energy, so that the small point of impact is molten for a short time and rapidly cooled. The process is repeated for all the particles 14.

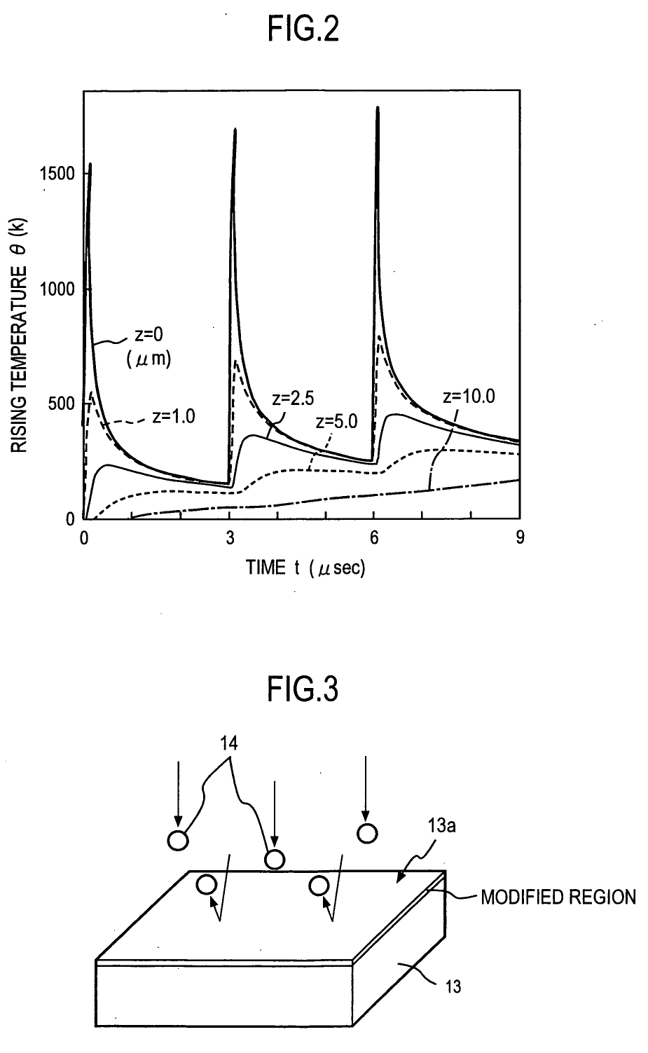

This phenomenon will be more clearly understood from the following description. For example, high-speed particles (spherical particles 14) are made to successively collide against the sample surface at a speed of about 200 m/s at intervals of 3 μs as pulses having a pulse width on the order of nanoseconds. Then, the result of numerical analysis of the resulting temperature distribution is as shown in FIG. 2 (see Noboru EGAMI, “Fatigue Strength Properties of Surface Modification Steel by Fine Particles Bombarding”, Surface Finishing Technology Vol. 52, No. 2, 1995, published by The Surface Finishing Society of Japan). That is, even if the spherical particles 14 are successively ejected from the nozzle 15, the spherical particles 14 collide against the surface of the to-be-modified base material 13 at random as shown in FIG. 3, for example. At each small point of impact on the to-be-modified base metal 13, a rapid heating and a rapid cooling process at a rate of 1000 K/μs or higher occur in a region extremely close to the surface, or to be specific, to a depth of 1 μm or less. The rapid heating and rapid cooling process are repeated at intervals of about 3 μs, for example. In FIG. 2, the parameter Z denotes the depth from the surface.

During the first modification treatment, the rapid melting and the rapid cooling described above repeatedly occur on the surface of the to-be-modified base material 13. In the rapid cooling process, the molten metal solidifies before the atoms are arranged in position and therefore is kept in a so-called amorphous state. That is, the minute irregularities on the surface of the to-be-modified base material 13 found before the first modification treatment are removed.

Then, according to the present invention, the second modification treatment is further performed. In the second modification treatment, each of spherical particles 14 having a diameter larger than that of the spherical particle 14 used for the first modification treatment, or more precisely, having a curvature smaller than the curvatures of the irregularities on the surface of the to-be-modified base material 13 having been subjected to the first modification treatment is made to collide at a high speed against the surface of the to-be-modified base material 13 having been subjected to the first modification treatment. In this case, except for the diameter, the conditions concerning the spherical particles 14 are the same as those concerning the spherical particles 14 used for the first modification treatment, and as the particle, an alumina particle is used, for example.

The second modification treatment can be performed simply by replacing a pressure tank 21 shown in FIG. 1 with a new one containing fine particles used for the second modification treatment. To this end, it is provided that pipes 23 and 26 can be removed from the pressure tank 21. Alternatively, the spherical particles 14 in the pressure tank 21 may be replaced with the spherical particles used for the second modification treatment.

If the spherical particles 14 having curvatures smaller than those of the spherical particles used in the first modification treatment collide against the surface of the to-be-modified base material 13, through the same mechanism as in the first modification treatment, the surface region of the to-be-modified base material 13 is changed into amorphous, the corrosion resistance thereof increases, the irregularities having large curvatures on the surface of the to-be-modified base material 13 are reduced, the surface is planarized, and the contact resistance of the surface is reduced.

It is known that, if a metal surface has irregularities of large curvatures, metal atoms at the irregularities have high chemical potentials, and such high chemical potentials cause corrosion of the surface of the base material starting at the irregularities. To prevent this, the first modification treatment is performed to change irregularities of significantly large curvatures into amorphous, thereby forming a natural oxide film through oxidation by oxygen in the air, that is, a passivation layer, on the surface thereof. However, the first modification treatment cannot enhance the electrical contactivity. On the contrary, in some cases, irregularities having larger curvatures than before the first modification treatment increase, and the irregularities have greater depth than before the first modification treatment. In other words, the first modification treatment may make the surface coarser, and in this case, the electrical contactivity is degraded. In addition, some of the irregularities of such increased curvatures tend to become a starting point of corrosion, and therefore, the corrosion resistance is not sufficiently improved. Thus, the second modification treatment is performed to planarize the surface having such irregularities. Since the planarization mechanism is the same as that of the first modification treatment, the planarization changes the surface into amorphous. Then, a passivation layer is formed on the resulting amorphous surface through oxidation by oxygen in the air, and the curvatures of the irregularities on the planarized surface are sufficiently smaller than those of the irregularities that can be a starting point of corrosion. Therefore, both the corrosion resistance and the electrical contactivity are improved.

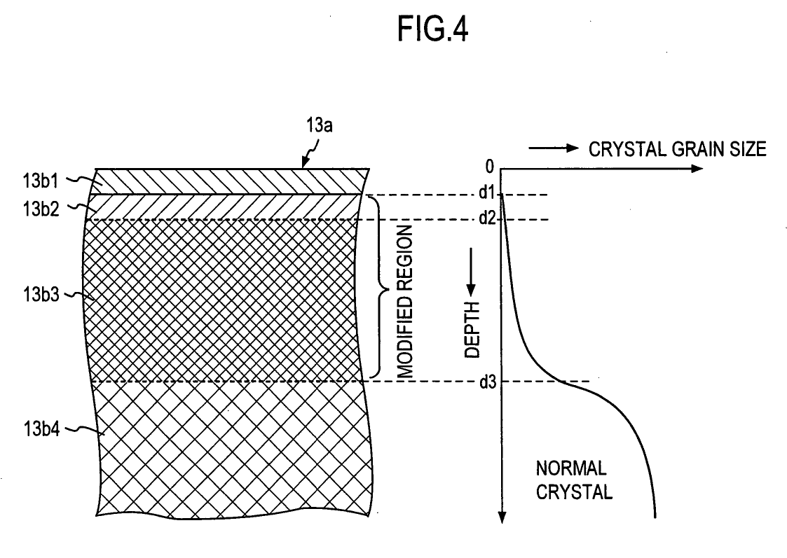

FIG. 4 shows a cross section of the to-be-modified base material 13 resulting from the two modification treatments and a change of crystal grain diameter over regions of the to-be-modified base material 13. In FIG. 4, the vertical axis indicates the depth from a surface 13a of the to-be-modified base material 13, and the horizontal axis indicates the crystal grain diameter. A surface passivation layer 13b1 is formed by natural oxidation to a depth d1 in the to-be-modified base material 13. Underlying the surface passivation layer 13b1, an amorphous layer 13b2 is formed to a depth d2. Underlying the amorphous layer 13b2, a refined crystal layer 13b3 is formed in which the crystal grain size increases with the depth from the surface. In the region at depths equal to or greater than a depth d3, there remains a base material layer 13b4 in which the state of the crystal grains of the to-be-modified base material 13 before the modification treatments is kept unchanged.

The spherical particle 14 used in the first modification treatment has a size enough to change the projection or recess of the largest curvature on the surface of the to-be-modified base material 13 before surface modification into amorphous. For example, it is enough that the spherical particle 14 has a diameter equal to or less than the distance across the projection or recess of the largest curvature of the irregularities on the surface before surface modification that can be a starting point of corrosion. When such a small particle is used, the ejection pressure is increased to achieve the repeated rapid melting and rapid cooling of the surface described above. That is, the size of the spherical particle 14 and the ejection pressure are determined so that the rapid melting and cooling can be achieved.

As for the second modification treatment, the quality of planarization increases with the size of the spherical particle 14, as described above. However, actually, the second modification treatment is restricted in terms of the availability of the particle, the inner diameter of the nozzle 15 or the like.

[Experiment]

Using phosphor bronze as the to-be-modified base material (simply referred to as sample, hereinafter), comparison experiments were performed under four different conditions described below. An alumina particle with relatively high fracture toughness was used as the particle 14, and the shape of the particle 14 was substantially spherical so that it did not etch the surface of the sample. The diameter of the nozzle 15 was 1.5 mm, the particle ejection pressure was 8 kg/cm², the ejection duration was 1 minute, and compressed air at room temperature was used for ejection of the particle. Here, except for the diameter of the particle 14, the first modification treatment and the second modification treatment were performed under the same condition.

Condition 1: the surface is treated only once using a particle having a diameter of 20 μm (comparison experiment).

Condition 2: the surface is treated only once using a particle having a diameter of 50 μm (comparison experiment).

Condition 3: after the surface is treated using a particle having a diameter of 50 μm, the surface is treated again using a particle having a diameter of 20 μm (comparison experiment).

Condition 4: after the surface is treated using a particle having a diameter of 20 μm, the surface is treated again using a particle having a diameter of 50 μm (embodiment 1 of the present invention).

After the surface modification treatment was performed under each of these conditions, a salt spray test was performed for 48 hours on each of the surface-modified samples to evaluate the corrosion resistance thereof. In addition, the salt spray test was performed also on a phosphor bronze base material (sample) that was not subjected to any surface modification treatment. In this case, the surface was completely rusted, and the contact resistance was significantly reduced. Based on this fact, it could be seen that the corrosion resistance improvement by the surface modification could be assessed by the salt spray test.

After the 48 hours of salt spray test, using a contact-resistance meter with a gold probe, the contact resistance of each sample was measured while changing the load from 1 g to 100 g. FIG. 5 shows the result. In FIG. 5, the horizontal axis indicates the load, and the vertical axis indicates the contact resistance. The measuring range of the contact resistance meter is from 0 mΩ to 20 mΩ. A curve 41 (solid line), a curve 42 (alternate long and short dash line), a curve 43 (dashed line) and a curve 44 (dotted line) indicate the experimental results for the samples treated under the conditions 1, 2, 3 and 4, respectively. In addition, a curve 45 (alternate long and two short dashes line) indicates the result of measurement of the contact resistance of the phosphor bronze base material that is not subjected to neither any surface modification treatment nor any salt spray, which is performed by similarly changing the load. It can be said that the curve 45 indicates a state of the sample that is suitable for commercialization.

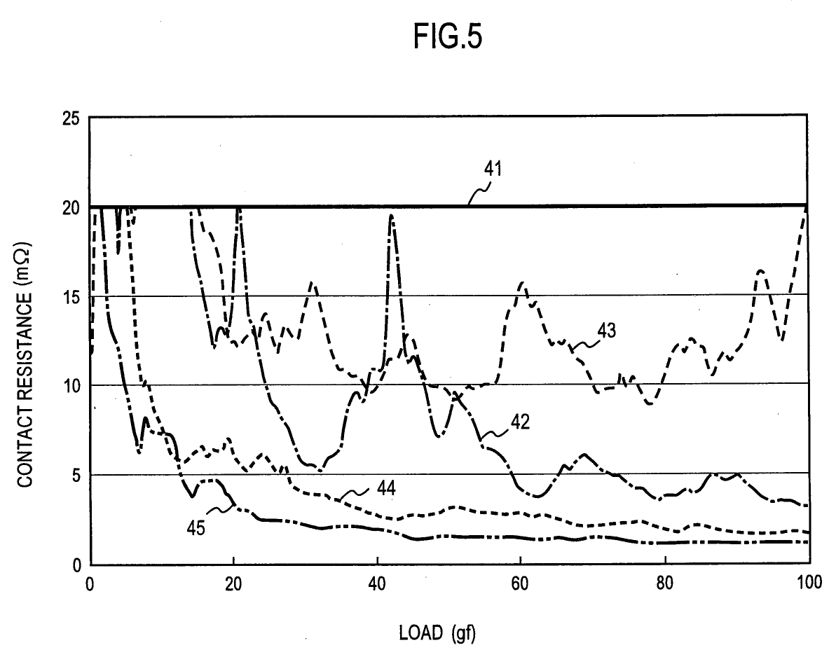

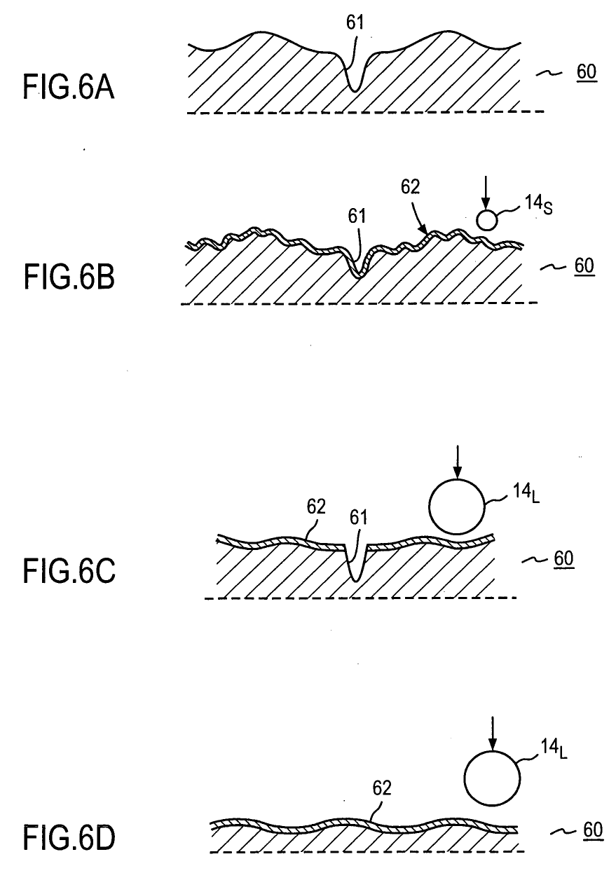

As indicated by the solid line 41, the sample treated under the condition 1 exhibited a contact resistance equal to or higher than 20 mΩ, which was the measurement limit, over the whole range of load and therefore was not suitable for commercialization. The reason for this will be described with reference to FIG. 6A, which is a cross-sectional view showing irregularities on the surface of a sample 60 yet to be surface-modified. In the modification treatment under the condition 1, the sample surface was bombarded with each of particles 14_{S} having a curvature larger than that of a recess 61 having the largest curvature before the modification treatment, that is, the smallest recess. As shown in FIG. 6B, for example, the modification treatment formed an amorphous layer 62 on the sample surface and many irregularities on the sample surface, although the irregularities had curvatures smaller than that of the recess 61. The irregularities are considered as a cause of the degradation of the contact resistance. In addition, irregularities of such curvatures can be a starting point of corrosion.

On the sample treated under the condition 2, there ware observed many corrosions starting from small recesses that the particle having a diameter of 50 μm couldn't get into. As a result, as indicated by the alternate long and short dash line 42, the contact resistance was significantly worse than before salt spray (see the alternate long and short two dashes line 45). In the modification treatment under the condition 2, the sample surface was bombarded with each of particles 1⁴L having a curvature smaller than those of irregularities on the surface before the modification treatment. Therefore, as shown in FIG. 6C, the interior of the recess 61 was not changed into amorphous by the particles 14_{L}. Therefore, the recess 61 served as a starting point of corrosion, so that the corrosion resistance was degraded. In other words, it can be considered that the interior of the recess 61 remained unmodified, and corrosion started from the recess 61 to degrade the contact resistance.

As for the sample treated under the condition 3, while the surface was planarized by the first modification treatment, small recesses remained on the surface as in the case of the condition 2. In addition, additional irregularities ware formed on the surface by the second treatment. Thus, as for the sample treated under the condition 3, it can be considered that not only the contactivity was degraded, but also corrosion occurred and the contact resistance was degraded as indicated by the dashed line 43.

Compared with the conditions 1 to 3 described above, the sample treated under the condition 4, that is, treated according to the embodiment 1 of the present invention exhibited an extremely preferred contact resistance, as indicated by the dotted line 44. This can be explained as follows. Because the entire surface was first modified along the irregularities using the particles having a diameter of 20 μm, that is, the entire surface was modified as shown in FIG. 6B, and then, the particles 14_{L} having a diameter of 50 μm, which had a curvature smaller than those of the irregularities on the surface, collided against the surface, irregularities having small curvatures ware planarized as shown in FIG. 6D, for example, the amorphous layer 62 was formed over the entire surface, and the surface had a high corrosion resistance and a high electrical contactivity. The curve 44 indicating the result of treatment of the sample under the condition 4 approximated to the curve 45. In other words, the contact resistance of the sample treated under the condition 4 was not significantly degraded, compared with the contact resistance of the unmodified phosphor bronze sample before salt spray which was a good sample for comparison.

The experimental results described above prove that the treatment under the condition 4 (according to the embodiment of the present invention) is extremely effective in improvement of corrosion resistance, compared with the treatments under the conditions 1 to 3. While particles having a diameter of 20 μm ware used as smaller particles 14 and particles having a diameter of 50 μm ware used as larger particles 14, of course, any particle diameter can be chosen depending on the size of irregularities on the surface of the to-be-modified base material for use.

Referring to the cross-sectional view of FIG. 4, in the case of the sample treated under the condition 4, the thickness of the passivation layer 13b1 was 10 Å or less, the thickness of the amorphous layer 13b2 was 10 Å or more, and the total thickness of the amorphous layer 13b2 and the refined crystal layer 13b3, that is, the thickness of the surface-modified layer was about 10 μm.

It is desirable that the thickness of the amorphous layer 13b2 is equal to or more than 10 Å. This is based on the descriptions that the thickness of the passivation layer is approximately 10 Å (“Practical Knowledge about Corrosion and Corrosion Prevention”, International Standard Book Number (ISBN): 4-274-08721-2, p. 10) and that the thickness of the passivation layer of a corrosion-resistant metal referred to as passivity metal is approximately 10 Å (“Handbook of Electrochemistry”, International Standard Book Number (ISBN): 4-621-04759-0, p. 427). The amorphous layer 13b2 has a higher volume resistivity than the refined crystal layer 13b3 and the base material layer 13b4 and, thus, preferably has a small thickness. Up to a thickness of passivation layer of about 100 Å, a sufficiently practical contact resistance can be achieved due to the tunnel effect even in the case of an insulating film. Provided that the effective area of the contact is 0.1 by 0.1 mm², and degradation of the volume resistivity of the amorphous layer 13b2 can be allowed up to two orders of magnitude, a sufficiently practical contact resistance can be achieved with the amorphous layer 13b2 having a thickness up to 1 μm.

If in the underlying layer the natural oxide film has only a few failures, the reaction does not proceed, and the natural oxide film constitutes a passivation layer. The thickness of the passivation layer is not greater than approximately 10 Å.

In the case of phosphor bronze, the irregularities on the surface yet to be modified, that is, the crystal grains have sizes from 10 to 20 μm. The diameter of the particle 14 used in the first modification treatment is preferably approximately equal to or less than 20 μm so that the smallest recess, that is, the recess having the largest curvature can be changed into amorphous. The diameter of the particle 14 used in the second modification treatment is preferably more than 20 μm. The material for the contact member is not limited to phosphor bronze and may be brass, Corson copper or the like.

[Embodiment 2]

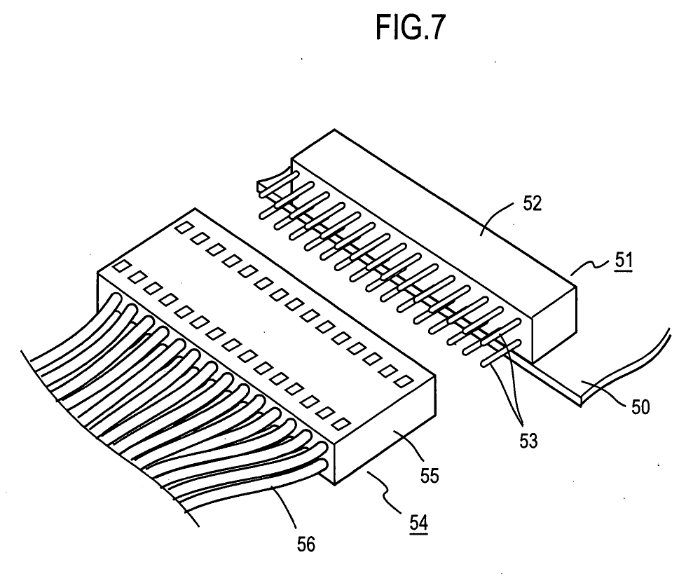

FIG. 7 shows a connector according to an embodiment 2 of the present invention. A connector (a plug in this example) 51 is mounted on a wiring board 50. A rectangular-parallelepiped housing 52 of the connector 51 is attached to the wiring board 50 along one edge thereof. From a surface of the housing 52 that extends along that edge and is perpendicular to the wiring board 50, two rows of pin-shaped contacts 53, whose surfaces are modified according to the present invention, protrude to the outside of the wiring board 50 in parallel with the plane of the wiring board 50. Although not shown, each pin-shaped contact 53 is connected to a wiring on the wiring board 50.

A socket connector 54, which is a counterpart of the plug connector 51, has a contact section composed of contact members, whose surface is modified according to the present invention, housed in a contact housing opening (not shown) of a housing 55 thereof. The pin-shaped contacts 53 can be connected to or disconnected from the contact section composed of contact members by inserting or removing the pin-shaped contacts 53 into or from the contact housing opening. A lead wire 56 having one end connected to each contact member of the socket connector 54 is led from the housing 55 to the outside.

Since the contact members have surfaces modified according to the present invention, the connectors establish a good electrical connection and have a high corrosion resistance and a long life. The pin-shaped contacts of the plug connector may be perpendicular to the wiring board 50. Furthermore, the present invention can be applied to various cases in which a different number of rows of contacts, a different number of contacts or the like is used.

What is claimed is:

1. A surface modification method for a conductive metal material, comprising:
a first modification step of bombarding the conductive metal material with spherical particles, each of which is made of a material that does not crack if the particle collides against the conductive metal material and has a curvature approximately equal to or more than curvatures of irregularities on the surface of the conductive metal material; and
a second modification step of bombarding the surface of the conductive metal material treated in the first modification step with spherical particles, each of which is made of a material that does not crack if the particle collides against the conductive metal material and has a curvature less than curvatures of irregularities on the surface of the conductive metal material treated in the first modification step.

2. The surface modification method for a conductive metal material according to claim 1, wherein the conductive metal material is phosphor bronze, brass or Corson copper.

3. A conductive metal material, wherein an amorphous layer having a thickness of at least 10 Å is formed at the surface of the conductive metal material,
the size of crystal grains of the conductive metal material under the amorphous layer decreases as the distance from the amorphous layer decreases, and
the surface of the amorphous layer is planarized compared with a surface having irregularities that become a starting point of corrosion.

4. A contact member that is made of the conductive metal material according to claim 3.

5. A connector that has a contact section that comprises the contact member according to claim 4.
